(19) United States
(12) Patent Application Publication
(10) Pub. No.: US 2013/0033560 A1
(43) Pub. Date: Feb. 7, 2013

(54) METHOD AND APPARATUS FOR ADDING CLOSED CAPTIONING TO VIDEO MAIL

(71) Applicants: Rajesh D. Rasalkar, Bolingbrook, IL (US); Rajesh K. Benjamin, Lisle, IL (US); Satyen S. Patel, Vernon Hills, IL (US)

(72) Inventors: Rajesh D. Rasalkar, Bolingbrook, IL (US); Rajesh K. Benjamin, Lisle, IL (US); Satyen S. Patel, Vernon Hills, IL (US)

(73) Assignee: Alcatel-Lucent USA Inc.

(21) Appl. No.: 13/198,791

(22) Filed: Aug. 5, 2011

(51) Int. Cl. H04N 7/025

(52) U.S. Cl. 348/14.01; 348/E07.017

(57) ABSTRACT

A computer-implemented method of providing closed captioning for video mail is described herein. The method includes receiving video mail from a calling party directed to at least one called party at a video mail server. Video mail from the calling party for at least one called party may be recorded at the video mail server. Further, closed captioning content may be added to the video mail for at least one called party at the video mail server. The video mail with closed captioning content for at least one called party may be stored in a video mail database in communication with the video mail server. At some point in time, an alert may be sent to the called party indicating that video mail has arrived via the video mail server or a short message service center.

### BACKGROUND OF THE INVENTION

The exemplary embodiments relate to a method and apparatus for adding closed captioning to video mail. While the exemplary embodiments are particularly directed to the art of telecommunications, and will be thus described with specific reference thereto, it will be appreciated that they may have usefulness in other fields and applications.

By way of background, video mail is a messaging system where a webcam is used to record a video message which can be sent as an email or in some other format. Some video mail services may require a download Client (computing) to work for the sender, while others offer a web-based option that allows the sender to send a video mail without a downloaded client. A video messaging system provides access to the recorded message through one of its designated service providers. The user then can retrieve the message through the same service provider and access this message from anywhere in the world. The sender records a message using their webcam or other technology, and sends the video message to the receiver who can then access and respond to the message. Messages can range from personal to business related, and they can also be sent to either one or many receivers. Depending on video message service provider, an account may or may not be required to send and receive messages.

With current video mail systems, however, the receiver does not have a way of viewing confidential messages. Thus, the only way to protect the privacy of the sender's audio in the public setting is for the user to mute the speaker on the playback device. Also, video mail for the hearing impaired is not useful. In addition, currently the receiver does not have a way to listen to audio in public places or where silence is required, e.g., meetings, conferences, movies, classrooms, etc. Further, the receiver does not have a way to listen to audio in loud environments such as football games, concerts, etc.

### SUMMARY OF THE INVENTION

A method and apparatus for providing closed captioning with video mail are provided.

In one embodiment, a computer-implemented method of providing closed captioning for video mail is provided. The method includes receiving video mail from a calling party directed to at least one called party at a video mail server. Video mail from the calling party for at least one called party may be recorded at the video mail server. Further, closed captioning content may be added to the video mail for at least one called party at the video mail server. The video mail with closed captioning content for at least one called party may be stored in a video mail database in communication with the video mail server. At some point in time, an alert may be sent to the called party indicating that video mail has arrived via the video mail server or a short message service center.

In another embodiment, an apparatus for providing closed captioning for video mail is provided. The apparatus includes a video mail server that is operative to receive video mail from a calling party directed to at least one other party, record video mail from the calling party for at least one called party, optionally add closed captioning content to the video mail, and optionally send an alert to at least one called party indicating that video mail has arrived at some point in time. The apparatus also includes a video mail database for storing subscriber data and video mail with and without closed captioning content.

In yet another embodiment, a non-transitory computer-usable data carrier storing instructions that, when executed by a computer, cause the computer to perform a method is provided. The method includes receiving video mail from a calling party directed to at least one called party at a video mail server. Video mail from the calling party for at least one called party may be recorded at the video mail server. Further, closed captioning content may be added to the video mail for at least one called party at the video mail server. The video mail with closed captioning content for at least one called party may be stored in a video mail database in communication with the video mail server. At some point in time, an alert may be sent to the called party indicating that video mail has arrived via the video mail server or a short message service center.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a block diagram of a system according to aspects of the exemplary embodiments; and

FIG. 2 is a flow chart of an exemplary method of providing closed captioning with video mail.

### DETAILED DESCRIPTION

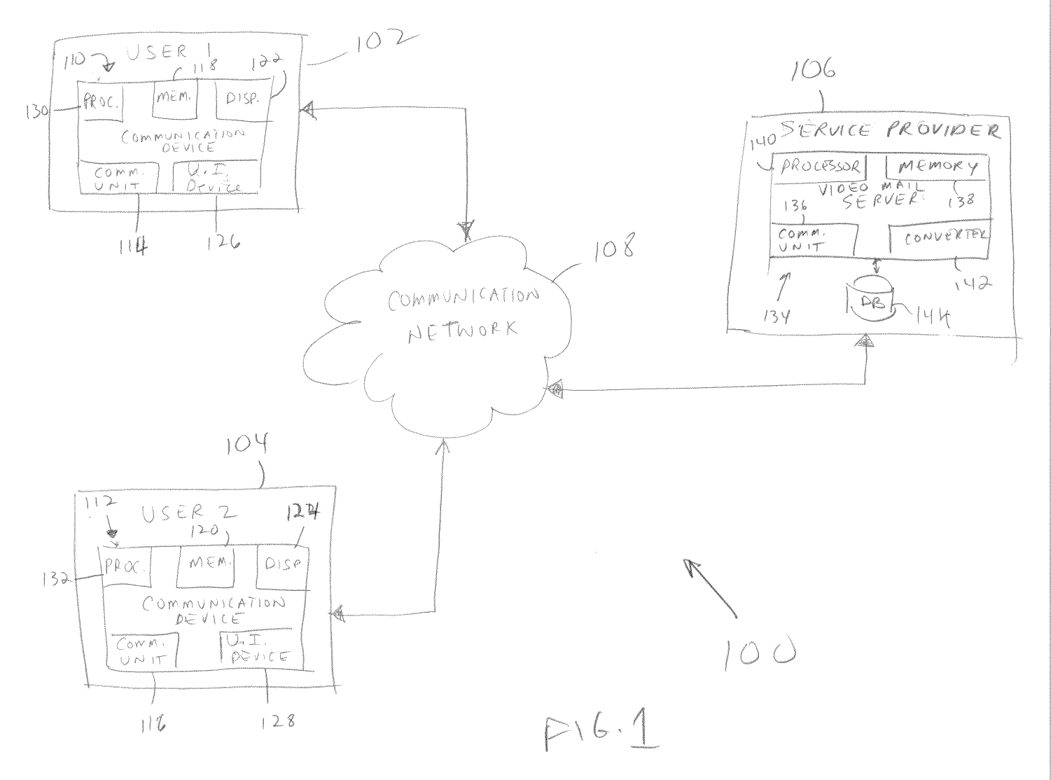

Referring now to the drawings wherein the showings are for purposes of illustrating the exemplary embodiments only and not for purposes of limiting the claimed subject matter, FIG. 1 provides a view of a system 100 into which the presently described embodiments may be incorporated.

The system 100 suitably includes at least two parties, such as a calling party 102 and a called party 104, and at least one service provider 106, interconnected by a communications network 108. It is to be understood that the calling party 102 may be sending video mail to a single called party 104 or broadcasting to a group of called parties 104. The communications network 108 is typically a wireless network, but other types of communications networks are contemplated. For example, the communications network 108 may incorporate one or more of the following technologies: 4G wireless technologies such as LTE (Long Term Evolution) and WiMAX, 3G wireless technologies such as WCDMA, HSDPA, HSUPA and HSPA, cable, DSL, satellite, and the like.

The parties (102, 104) generally communicate with each other over the communications network 108 via a plurality of communication devices. Thus, each of the parties (102, 104) is suitably embodied by a communication device (110, 112), such as a laptop, a personal computer, a cell phone, a smart phone, a PDA, a tablet, and the like, connected to the communications network 108. Further, each of the communication devices (110, 112) optionally includes components such as a communications unit (114, 116), at least one memory (118, 120), a display (122, 124), a user input device (126, 128), a processor (130, 132), and the like. The communications units (114, 116) allow the communication devices (110, 112) to interact with other components connected to the communications network 108. The memories (118, 120) include computer executable instructions for performing various functions associated with the parties (102, 104). The displays (122, 124) display the graphical user interfaces (e.g., via web browsers) facilitating interaction with the communication devices (110, 112). The user input devices (126, 128) allow the parties (102, 104) to create and record various types of messages, including video mail which generally includes video and audio portions. Accordingly, the user input devices (126, 128) generally include at least one video input component, such as a webcam or video camera (not shown), and at least one audio input component, such as a microphone (not shown). The processors (130, 132) execute the computer executable instructions on the memories (118, 120).

One or more video mail servers 134 suitably embody each of the service providers 106. Each of the video mail servers 134 includes one or more of a communications unit 136, at least one memory 138, at least one processor 140, and the like. The communications units 136 allow the video mail servers 134 to interact with other components connected to the communications network 118. The memories 138 include computer executable instructions for performing the various functions associated with the parties (102, 104). The processors 140 execute the computer executable instructions on the memories 138.

The video mail servers 134 generally facilitate the transmission of video mail messages between the parties (102, 104). As shown in FIG. 1, the video mail servers 134 may include a closed captioning unit 142 for providing closed captioning content to video mail delivery. Suitably, the closed captioning unit 142 may employ a speech-to-text engine (converter) to achieve this functionality. There are open source converters that are available. The speech-to-text conversion suitably takes place once the video message has been delivered and saved on the server 134. Based on the user's subscription, the video mail can be retrieved with closed captioning on. It is to be understood that there are various types of methods/applications on the parties' devices for accessing the video mail and providing captioning and language selection. The service provider 106 can charge the parties for this feature or service. The feature may be modified as needed by the subscriber via any suitable means such as text messaging, the service provider's website, and the like. The language detection feature is based upon available open source converters. Typically, the language is selected based on the user subscription, or the language can be selected by the called party 104. Generally, only the called party 104 needs to be subscribed to the closed captioning service. The called party 104 typically controls whether they need captioning for video mail. It is also noted that while any language can be employed by the calling party 102, such language should be consistent throughout the video mail. If there is music or some other background noise in the audio, the speech-to-text algorithm employed is typically adapted to filter out any unwanted background noise. The called party 104 may be able to control where the captioning is placed, depending on the communication device. For example, the captioning can be placed outside the original video frame or it may obstruct at least part of the video.

Each of the video mail servers 134 is generally in communication with at least one video mail database 144 for storing subscriber data, video mail without closed captioning, and video mail with closed captioning, among other things.

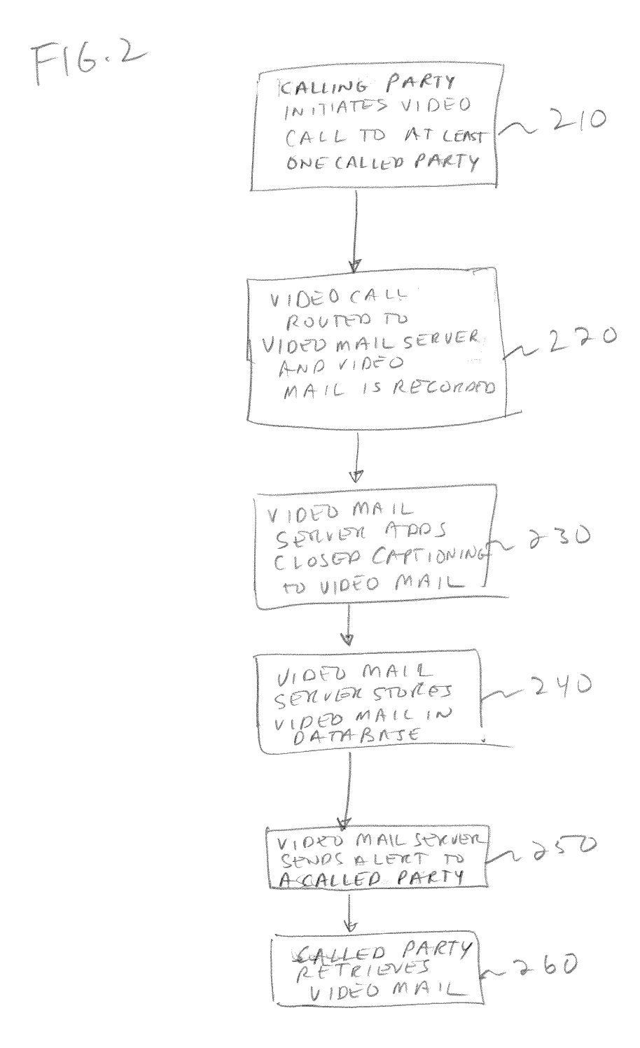

FIG. 2 shows a flow chart which illustrates the basic operation of the exemplary method. Note that the acts are listed in a particular order in the flow chart. However, this order should not be considered limiting, as the order of many of these acts may be changed without affecting the resulting method. As shown in FIG. 2, initially the calling party 102 initiates a video call to at least one called party 104 via the network 108 (210). In one embodiment, one or more components in the network 108 are adapted to determine whether a video call is involved and subsequently route such video calls to the appropriate video mail server 134. In another embodiment, the calling party 102 communicates directly with the video mail server 134. In either case, the video call is received by the video mail server 134 where the video mail is subsequently recorded (220).

Suitably, the video mail server 134 provides closed captioning content to the video mail (230). The video mail server 134 may also store the video mail with closed captioning content in the database 144 (240). The video mail server 134 may send an alert (e.g., visual, audio, text, e-mail, etc.) to at least one called party 104, indicating that video mail has arrived, via the network 108 (250). The alert may be sent immediately or it may be sent periodically. Further, an alert may be sent when a specific quantity of video mail has been received for the called party at the video mail server 134. When an alert in the form of a text message (SMS message) is sent to a called party 104, the message gets stored in an SMSC (short message service center) (not shown), which delivers it to the called party when they are available. This is a store and forward option. An SMSC is responsible for handling the SMS operations of a wireless network. When an SMS message is sent from a mobile phone, it will reach an SMS center first. The SMS center then forwards the SMS message towards the destination. The main duty of an SMSC is to route SMS messages and regulate the process. If the recipient is unavailable (for example, when the mobile phone is switched off), the SMSC will store the SMS message. It will forward the SMS message when the recipient is available.

A called party 104 may retrieve the video mail from the video mail server at any time (260). It is to be understood that the length of time that video mail may be stored on the database 144 may be set either by the service providers 106 or by the parties (102, 104).

It is to be appreciated that suitably, the methods and systems described herein are embodied by a computer, or other digital processing device including a digital processor, such as a microprocessor, microcontroller, graphic processing unit (GPU), etc. and storage. In other embodiments, the systems and methods may be embodied by a server including a digital processor and including or having access to digital data storage, such server being suitably accessed via the Internet or a local area network, or by a personal data assistant (PDA) including a digital processor and digital data storage, or so forth. The computer or other digital processing device suitably includes or is operatively connected with one or more user input devices, such as a keyboard, for receiving user input, and further includes, or is operatively connected with, one or more display devices. In other embodiments, the input for controlling the methods and systems is received from another program running previously to or concurrently with the methods and systems on the computer, or from a network connection, or so forth. Similarly, in other embodiments the output may serve as input to another program running subsequent to or concurrently with methods and systems on the computer, or may be transmitted via a network connection, or so forth.

In some embodiments, the exemplary methods, discussed above, the system employing the same, and so forth, of the present application are embodied by a storage medium storing instructions executable (for example, by a digital processor) to implement the exemplary methods and/or systems. The storage medium may include, for example: a magnetic disk or other magnetic storage medium; an optical disk or other optical storage medium; a random access memory (RAM), read-only memory (ROM), or other electronic memory device or chip or set of operatively interconnected chips; an Internet server from which the stored instructions may be retrieved via the Internet or a local area network; or so forth.

It is to further be appreciated that in connection with the particular exemplary embodiments presented herein certain structural and/or functional features are described as being incorporated in defined elements and/or components. However, it is contemplated that these features may, to the same or similar benefit, also likewise be incorporated in other elements and/or components where appropriate. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

It is also to be appreciated that particular elements or components described herein may have their functionality suitably implemented via hardware, software, firmware or a combination thereof. Additionally, it is to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

Even more, it is to be appreciated that, as used herein, a memory includes one or more of a non-transient computer readable medium; a magnetic disk or other magnetic storage medium; an optical disk or other optical storage medium; a random access memory (RAM), read-only memory (ROM), or other electronic memory device or chip or set of operatively interconnected chips; an Internet server from which the stored instructions may be retrieved via the Internet or a local area network; or so forth. Further, as used herein, a processor includes one or more of a microprocessor, a microcontroller, a graphic processing unit (GPU), an application-specific integrated circuit (ASIC), a field-programmable gate array (FPGA), and the like; a communications network includes one or more of the Internet, a local area network, a wide area network, a wireless network, a wired network, a cellular network, a data bus, such as USB and I2C, and the like; a user input device includes one or more of a mouse, a keyboard, a touch screen display, one or more buttons, one or more switches, one or more toggles, and the like; a database includes at least one memory; and a display includes one or more of a LCD display, an LED display, a plasma display, a projection display, a touch screen display, and the like.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A computer-implemented method of providing closed captioning for video mail, the method comprising:
receiving video mail from a calling party directed to at east one called party at a video mail server;
recording video mail from the calling party for at east one called party at the video mail server;
adding closed captioning content to the video mail for at least one called party at the video mail server;
storing the video mail with closed captioning content for at least one called party in a video mail database; and
sending an alert to at least one called party indicating that video mail has arrived via the video mail server or a short message service center.

2. The method of claim 1, wherein the video mail includes an original video frame and the closed captioning content is placed outside the original video frame.

3. The method of claim 1, wherein the video mail includes an original video frame and the closed captioning content is placed such that it obstructs at least part of the original video frame.

4. The method of claim 1, wherein the video mail from the calling party comprises a broadcast to a group of parties.

5. The method of claim 1, further comprising:
receiving a request from at least one called party to retrieve the video mail with closed captioning content from the video mail database; and
sending the video mail with closed captioning to the called party that requested the video mail with closed captioning content.

6. An apparatus for providing closed captioning for video mail, the apparatus comprising:
a video mail server that is operative to receive video mail from a calling party directed to at least one called party, record video mail from the calling party for at least one called party, add closed captioning content to the video mail, and send an alert to at least one called party indicating that video mail has arrived; and
a database for storing data including subscriber data, video mail without closed captioning content, and video mail with closed captioning content.

7. The apparatus of claim 6, wherein the video mail includes an original video frame and the video mail server is further operative to place the closed captioning content outside the original video frame.

8. The apparatus of claim 6, wherein the video mail includes an original video frame and the video mail server is operative to place the closed captioning content such that it obstructs at least part of the original video frame

9. The apparatus of claim 6, wherein the video mail from the calling party comprises a broadcast to a group of parties.

10. The apparatus of claim 6, wherein the video mail server is further operative to receive a request from the called party to retrieve the video mail with closed captioning from the database and send the video mail with closed captioning to the called party.

11. A non-transitory computer-usable data carrier storing instructions that, when executed by a computer, cause the computer to:
receive video mail from a calling party directed to at least one called party at a video mail server;
record video mail from the calling party for at least one called party at the video mail server;
add closed captioning content to the video mail for at least one called party at the video mail server;
store the video mail with closed captioning content for at least one called party in a video mail database; and
send an alert to the called party indicating that video mail has arrived via the video mail server or a short message service center.

12. The non-transitory computer-usable data carrier of claim 11, wherein the video mail includes an original video frame and the closed captioning content is placed outside the original video frame.

13. The non-transitory computer-usable data carrier of claim 11, wherein the video mail includes an original video frame and the closed captioning content is placed such that it obstructs at least part of the original video frame.

14. The non-transitory computer-usable data carrier of claim 11, wherein the video mail from the calling party comprises a broadcast to a group of parties.

15. The non-transitory computer-usable data carrier of claim 11, wherein the method further comprises:
receiving a request from at least one called party to retrieve the video mail with closed captioning content from the video mail database; and
sending the video mail with closed captioning to the called party that requested the video mail with closed captioning content.
